(19) United States
(12) Patent Application Publication
(10) Pub. No.: US 2007/0282681 A1
(43) Pub. Date: Dec. 6, 2007

(54) Method of obtaining and using anonymous consumer purchase and demographic data

(76) Inventors: Eric Shubert, Pleasanton, CA (US); Darcy Frew, Pleasanton, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/445,094

(22) Filed: May 31, 2006

(51) Int. Cl. G06Q 30/00

(52) U.S. Cl. 705/14

(57) ABSTRACT

This invention relates to a novel method of obtaining and using anonymous consumer purchase and demographic data that comprises providing a multi vendor capable instrument, such as a uniquely identifiable card, to the consumer for use during consumer purchases. The consumer is invited to anonymously register the instrument (e.g. card). This registration process invites the user to provide anonymous demographic data. Uniquely identifying information, such as name, address, phone number, and/or birth date is not be requested. When consumers then use the card during purchases, sales information is automatically captured at the point of sale. The demographic information and the consumer purchase information can be linked to obtain a clear picture of the demographics of the consumers that made the purchases. This information can then be used for a variety of purposes, including marketing research.

### BACKGROUND OF THE INVENTION

A. Field of the Invention

This invention relates to a novel method of obtaining and using anonymous consumer purchase and demographic data.

B. Description of the Prior Art

Methods exist in the art to obtain and use demographic and consumer purchase data. However, all of these methods require the user to provide at least one uniquely identifying personal fact, such as name, street address, city, phone number, or exact date-of-birth, among others. Consumers have grown increasingly alarmed at the invasion and occasional abuse of their personal privacy, i.e., the use of their name, address, phone number, and typically numerous other personal facts such as income, birth date, and household size. There have been many efforts to restrict or ban this activity at both state and federal levels to help protect consumer privacy. Conversely, much of the private consumer data that marketers, retailers, and others seek is useful to them, and can ultimately benefit the consumer as well. For example, by knowing their customers' spending and buying habits, retailers can utilize this data to provide the optimal product assortment, inventory, promotions and pricing, etc. They can also determine the effectiveness of their marketing programs by gauging repeat rates, promotion response and sales trends. In addition, further consumer segmentation can be performed based on consumer demographic information which will enable marketers to provide focused efforts on specific demographic groups and enable enhanced marketing efforts to particular consumers based on variables such as geographical location, age of consumer, gender of consumer, etc. This will allow retailers to become more efficient with their marketing expenditures and allow for targeting specific groups of consumers.

Unfortunately, while the collection and analysis of such data can be of great public benefit, it can also be the subject of considerable abuse. The reason some or many of these uniquely identifying personal information questions are included is because through data aggregation using many different data sources, including credit reports, mailing lists, telemarketing lists, etc., this information can be used as additional revenue streams for companies involved in market research and advertising.

While it is agreed that consumer demographic information is invaluable to retailers and marketers alike, interestingly, none of this uniquely identifying personal information is necessary in order to analyze and effectively utilize demographic, survey, and other forms of market research data. Additionally, some of the uniquely identifying information volunteered by consumers has been used to further the growing problem of identity theft, as well as cause unwanted solicitations. Unwanted and/or unrequested solicitations relating to the collection of consumer data can include any unsolicited contact, including telemarketing, direct phone calls, direct mail, third party mailing lists, and e-mail spam. These problems have limited consumer interest and curtailed participation in these data collection efforts.

Another commonly utilized method for collecting and analyzing consumer demographic information linked with purchase data is through the use of sample groups. Representative sample groups are typically less than 1% of a given consumer population. The demographics and purchase behavior of this small group of consumers is then modeled to predict the demographics and purchase behavior of the total population. This method has resulted in limited accuracy and usefulness of the modeled data.

C. Discussion of Prior Art

The existing art includes methods such as the Harms patent (U.S. Pat. No. 6,070,147), which is a “customer identification and marketing analysis system”. Unfortunately, this system ensures that uniquely identifying information is collected when consumers participate. This method, as well as others like it, such as Wong (U.S. Pat. No. 6,119,933) puts participating customers at risk for unwanted solicitations and identity theft.

Attempts have been made to reduce the likelihood of unwanted solicitations and identity theft. For instance, the Veldhisen patent (U.S. Pat. No. 6,480,850) collects uniquely identifying information, but attempts to keep that information stored in another location from publicly available information. This type of system is cumbersome and still does not eliminate the potential for disseminating participants' uniquely identifying information.

The Fusz application (United States Patent No. 20040176995) provides a method for consumers to provide themselves with marketing data via generating an anonymous consumer profile. However, this method is designed to provide only the consumer with marketing data, not to obtain and use anonymous consumer purchase and demographic data.

Therefore, there exists a need in the field of marketing, demographics, and data collection to provide a method of obtaining and using anonymous consumer purchase and demographic data, as well as a method for eliminating unrequested solicitations relating to the collection of consumer data.

### SUMMARY OF THE INVENTION

The invention is based on new methods for collecting consumer demographic information and providing marketers, retailers, and others with private and/or confidential consumer data that can provide a clear understanding of their actual customers as a group, or as specific subgroups, including information about their customers' geography, buying habits, demographics, etc., while protecting the privacy and identity of individual consumers. The term “consumer” can include anyone who purchases a product or service either for themselves, for others, or for any kind of business. This method employs a database that will combine the anonymous consumer information such as demographics with actual consumer purchases at participating retailers. Accordingly, this invention does not utilize uniquely identifying personal information that can potentially result in unwanted solicitations and identity theft. As such, it is anticipated that this method will create consumer confidence in revealing useful, yet non-uniquely identifying data and opinions. It is also anticipated that this method will increase consumer confidence and participation in consumer data collection and utilization efforts, which will in turn increase the accuracy and usefulness of the information.

From this anonymous database, anonymous consumer demographic data will be combined with their actual purchase data at participating retailers thereby significantly increasing the accuracy of consumer purchase behavior information well beyond traditional sample group methods used today. FIG. 3 demonstrates how each individual participating consumer's demographic and purchase data will be aggregated and provided to merchants and/or manufacturers for use in, but not limited to, marketing analysis, consumer behavior reports, and modeling. This consumer purchase behavior data will be used by retailers in any variety of marketing research applications such as category management, demographic segmentation, demographic clustering, promotion evaluation, pricing optimization, and product assortment analysis. Such detailed information also enables retailers to enhance their products and services offered to consumers and facilitate a better shopping experience for consumers while assisting retailers in meeting company goals through increased sales and profits.

### SHORT DESCRIPTION OF THE INVENTION

This invention relates to a novel method of obtaining and using anonymous consumer purchase and demographic data that comprises providing a multi vendor capable instrument, such as a uniquely identifiable card, to the consumer for use during consumer purchases. The consumer will then be invited to anonymously register the instrument (e.g. card). This registration process will invite the user to provide anonymous demographic data, such as gender, age, ethnicity, education, household size, marital status, income, and zip code. Uniquely identifying information, such as, but not limited to, name, street address, city, phone number, or birth date will not be requested.

It is anticipated that participating retailers will institute reward/loyalty programs. One example of a program will be reducing the price of certain items to consumers who use the card, to motivate consumers to use the card when making purchases. Another example is that consumers will earn points for items purchased at the retailer. Consumers can then redeem points earned at retailers for products and services at any of the participating retailers.

When consumers use the card during purchases, sales information is automatically captured at the point of sale. Then, the demographic information and the consumer purchase information can be linked in one central database to obtain a clear picture of the demographics and purchase behavior of the consumers that made the purchases. This information can then be used for a variety of purposes, including marketing research.

### BRIEF DESCRIPTION OF DRAWINGS

FIG. 1 is a schematic diagram of an embodiment of the method described herein.

FIG. 2a identifies the demographic data typically obtained using previously existing methods.

FIG. 2b identifies the anonymous demographic data typically obtained using the method described herein.

FIG. 3 shows a consumer's buying behavior matched to their anonymous demographic data.

### DETAILED DESCRIPTION OF THE DRAWINGS

A. Obtaining Consumer Demographic Data

One component associated with the systems and methods for anonymous collection of consumer data is the process of obtaining and registering a consumer “rewards” card that each consumer will carry, and can be used at any participating business.

In one embodiment, a consumer takes a free card at a participating business, and is allowed to use that card a limited number of times at any participating retailer for discounts and other rewards without registering the new card. The card has a unique number (or other indicia), either by a printed number on the back of the card or a removable sticker with the card number affixed to the card, and a magnetic strip (or other means) that provides support for the card system.

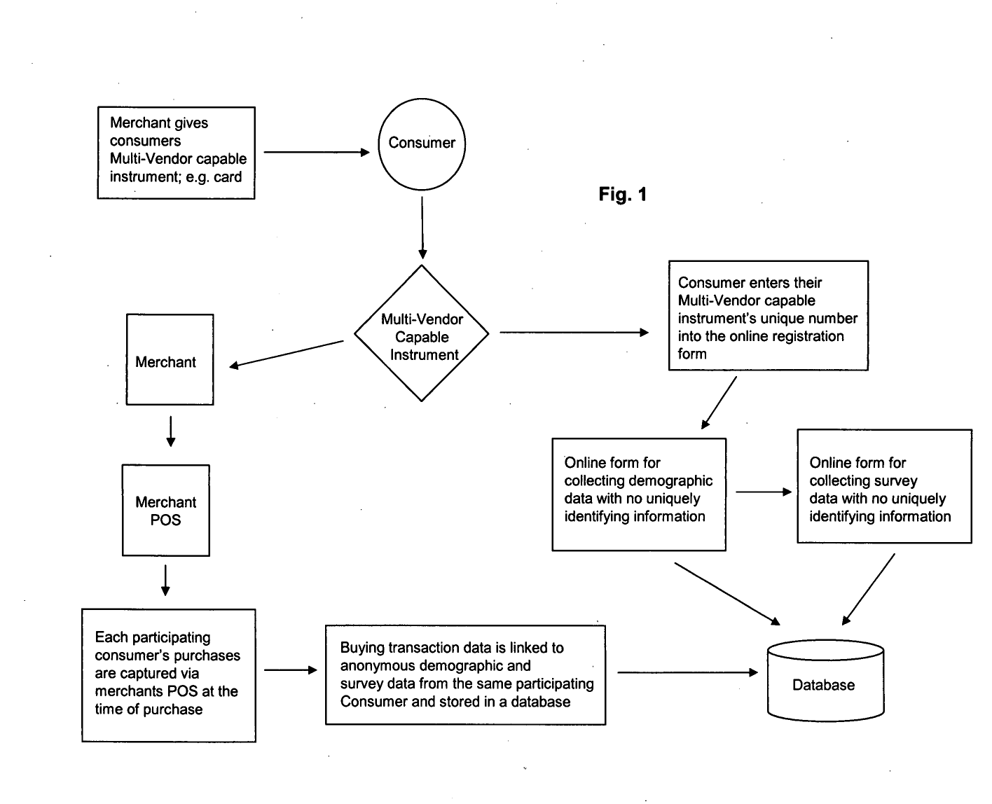

FIG. 1 illustrates an exemplary basic relationship between the card the consumer carries, and the point-of-sale data that participating merchants provide to the company implementing the program.

Another component associated with this embodiment of the system and methods for anonymous collection of consumer data is that sometime during the first several uses of the card, the consumer will be required to access the website identified on the back of the card by means of an Internet connection, enter the unique card number associated with the card in some way, either by printing the number on the back of the card or applying a removable sticker with the card number affixed to the card, and complete the anonymous questionnaire. The questions comprise common demographic and market research questions while protecting anonymity. The questions do not ask for uniquely identifying personal information, such as name, street address, city, phone number, exact date-of-birth, etc. Thus, the information provided is enough to track the particular consumer in relation to the card, but it is not enough to put the consumer at risk if the consumer loses the card or the card information is otherwise revealed.

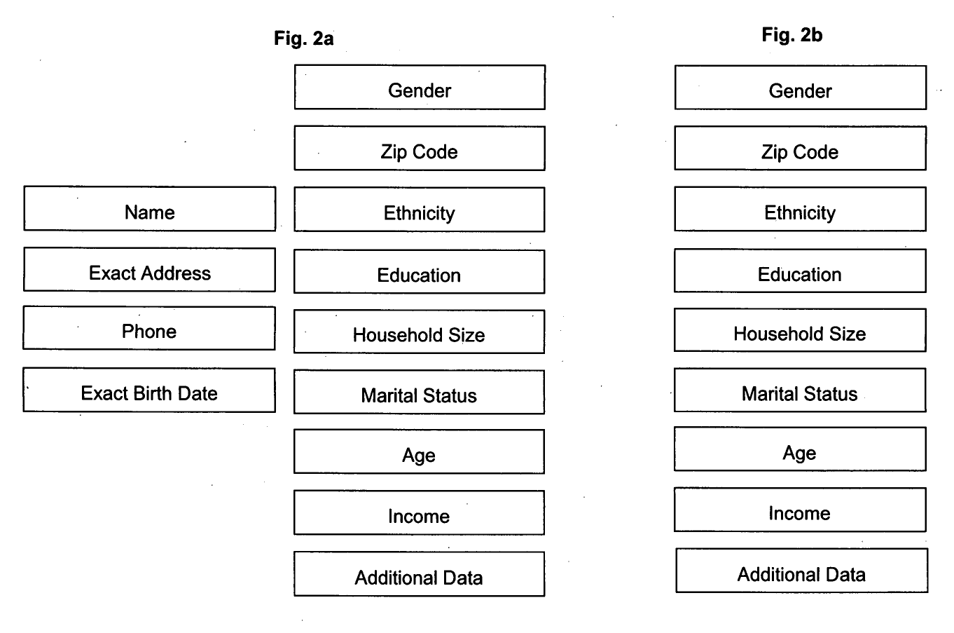

FIG. 2a illustrates how consumer data has been traditionally collected, which includes uniquely identifying each consumer, in contrast to the method of collecting anonymous consumer demographic data. For example, while existing methods may have requested the consumer's zip code and birth year, uniquely identifying personal information, such as name, street address, city, social security number, exact birth date, phone number etc., would also be requested.

FIG. 2b illustrates examples of the anonymous information collected and used in the method described herein. This anonymous data cannot be used to obtain uniquely identifying information about the consumer from the information collected during the registration process. People with the same zip code and birth year in any given zip code are generally believed to be non-unique.

This anonymous registration associates a unique card number with a unique demographic and marketing research profile. Furthermore, the data obtained from each consumer is more accurate than in other methods because of the anonymity of the user, as well as the knowledge that accurate and honest responses enhance each consumer's shopping experience through lower prices, better selection and better service.

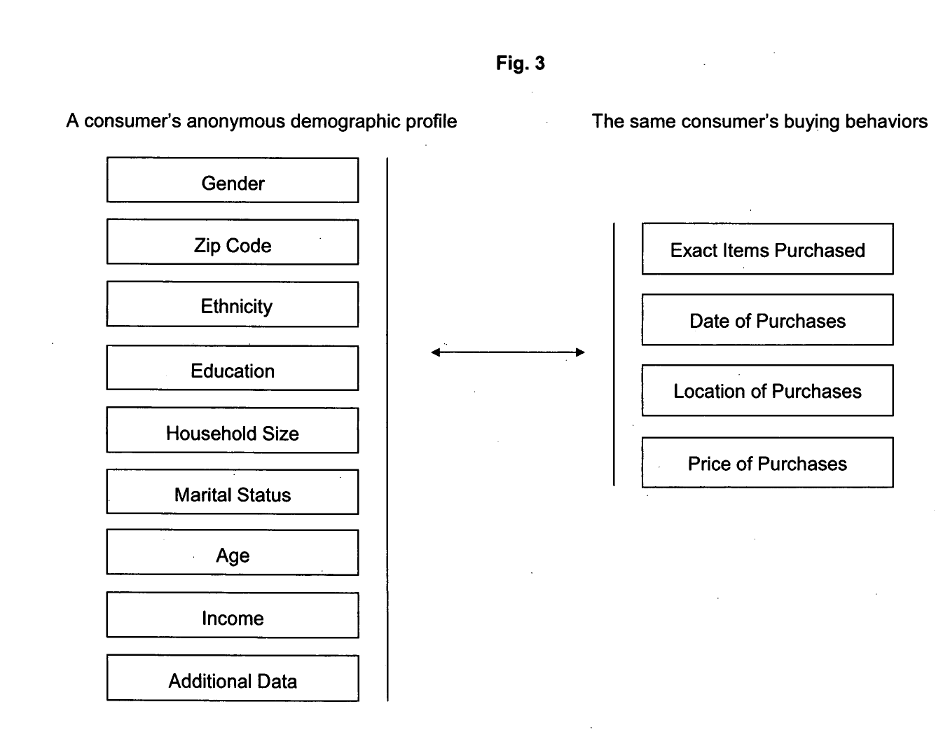

FIG. 3 shows that from the anonymous database obtained via the method described herein, anonymous consumer demographic data can be combined with their actual purchase data at participating retailers thereby significantly increasing the accuracy of consumer purchase behavior well beyond traditional sample group methods used today. FIG. 3 demonstrates how each individual participating consumer's demographic and purchase data can be aggregated and provided to retailers and/or manufacturers for use in, but not limited to, marketing analysis, consumer behavior reports, and modeling. This consumer purchase behavior data can be used by retailers and manufacturers in a variety of marketing research applications such as category management, demographic segmentation, demographic clustering, promotion evaluation, pricing optimization, and product assortment analysis. This data will be useful in enhancing consumer's shopping experience while assisting retailers in meeting company goals through increased sales and profits.

B. Anonymous Survey Capabilities

Other embodiments allow for custom, yet still anonymous, surveys that can provide further insight into consumer's shopping behavior and attitudes. These custom surveys will ideally originate at the request of the company running the program or at the request of a merchant or manufacturer.

The surveys can be omnibus or targeted to specific shopping groups based on any number of variables relating to buying behavior and demographics, while keeping individual survey responses completely anonymous. In one example, these surveys will be fielded via the same internet site where consumers originally registered their card. Consumers may be invited to participate in a survey. Because no uniquely identifying information is collected on the website, responses to the survey remain completely anonymous.

C. The Rewards Program

Another embodiment for anonymous collection of consumer data includes a consumer use incentive program, (i.e. “rewards” program).

The rewards Program may comprise a reward that each participating merchant designates for purchase of products or services, provided the consumer uses their card at the time of purchase. Consumers will earn and redeem rewards at any of the participating merchants.

As discussed above, it is anticipated that this method will increase consumer confidence and participation in consumer data collection and utilization efforts, which will in turn increase the accuracy and usefulness of the information.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

I claim:

1. (canceled)

2. (canceled)

3. (canceled)

4. (canceled)

5. (canceled)

6. (canceled)

7. (canceled)

8. A method comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

9. A method of collecting consumer purchase data relating to participating individuals' purchase choices without disclosure of uniquely identifying information to any third party comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

10. A method of protecting an individual's anonymity during the collection of consumer purchase data comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

11. A method of preventing third parties from identifying an individual based on that individual's use of a multi vendor capable instrument comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

12. A method of obtaining and using anonymous consumer purchase and demographic data comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

13. A method for eliminating unrequested solicitations relating to the collection of consumer data comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

14. A method for eliminating the risk of identity theft associated with the collection of consumer data comprising:
a. Providing a multi vendor capable instrument to a consumer for use during consumer purchases;
b. Inviting the consumer to anonymously register the instrument;
c. Receiving anonymous demographic information from consumer;
d. Receiving consumer purchase data associated with use of the instrument; and
e. Linking the consumer's anonymous demographic and consumer purchase data.

15. The method of claim 1, 2, 3, or 4 wherein the demographic information is stored in an electronic file.

16. The method of claim 1, 2, 3, or 4 wherein registering the instrument comprises accessing a web site or other user interface and entering a unique identifier that identifies a particular anonymous consumer profile.

17. The method of claim 1, 2, 3, or 4 wherein the anonymous demographic information may comprise any or all of the following information: gender, zip code, ethnicity, education, household size, marital status, age, income, and any other anonymous data.

18. The method of claim 1, 2, 3, or 4 further comprising a consumer use incentive program.
